(19) United States
(12) Patent Application Publication
(10) Pub. No.: US 2025/0056119 A1
(43) Pub. Date: Feb. 13, 2025

(54) ACTUATOR FOR OPTICAL IMAGING STABILIZATION AND CAMERA MODULE INCLUDING THE SAME

(71) Applicant: Samsung Electro-Mechanics Co., Ltd., Suwon-si (KR)

(72) Inventors: Sang Yong KIM, Suwon-si (KR); Seok Hwan KIM, Suwon-si (KR); Chi Hyeon JEONG, Suwon-si (KR)

(73) Assignee: Samsung Electro-Mechanics Co., Ltd., Suwon-si (KR)

(21) Appl. No.: 18/767,590

(22) Filed: Jul. 9, 2024

(30) Foreign Application Priority Data
Aug. 10, 2023 (KR) 10-2023-0104547

(51) Int. Cl. H04N 23/68; H04N 23/51; H04N 23/52

(52) U.S. Cl. CPC H04N 23/685; H04N 23/51; H04N 23/52

(57) ABSTRACT

An actuator for optical image stabilization includes a fixed frame; a moving frame, accommodated in the fixed frame, configured to move relatively to the fixed frame on a plane perpendicular to an optical axis; and a sensor substrate, on which an image sensor is disposed, comprising a fixed portion coupled to the fixed frame, a moving portion comprising the image sensor and coupled to the moving frame, and a connecting portion disposed between the moving portion and the fixed portion to support movement of the moving portion. The moving portion includes a heat dissipation member dissipating heat generated from the image sensor, and the heat dissipation member includes a substrate having a through-hole, and a conductive electrode filling the through-hole.

### CROSS-REFERENCE TO RELATED APPLICATIONS

This application claims the benefit under 35 USC 119 (a) of Korean Patent Application No. 10-2023-0104547 filed on Aug. 10, 2023, in the Korean Intellectual Property Office, the entire disclosure of which is incorporated herein by reference for all purposes.

### BACKGROUND

### 1. Field

The following description relates to an actuator for optical image stabilization and a camera module including the same.

### 2. Description of the Background

Camera modules are used in mobile communications terminals such as tablet personal computers (PCs), laptops, and smartphones.

In addition, camera modules used in portable electronic devices are equipped with an autofocus function (AF) and an image stabilization function (OIS) to generate high-resolution images. For example, the camera module performs focusing by moving a lens module in an optical axis (Z-axis) direction and performs optical image stabilization by moving the lens module in a direction perpendicular to the optical axis (Z-axis) direction.

However, recent improvements in the performance of camera modules have caused an increase in the weight of the lens module, resulting in a problem in that it is difficult to precisely control the driving force when moving the lens module for optical image stabilization.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an actuator for optical image stabilization includes a fixed frame; a moving frame, accommodated in the fixed frame, configured to move relatively to the fixed frame on a plane perpendicular to an optical axis; and a sensor substrate, on which an image sensor is disposed, comprising a fixed portion coupled to the fixed frame, a moving portion comprising the image sensor and coupled to the moving frame, and a connecting portion disposed between the moving portion and the fixed portion to support movement of the moving portion. The moving portion includes a heat dissipation member dissipating heat generated from the image sensor, and the heat dissipation member includes a substrate having a through-hole, and a conductive electrode filling the through-hole.

The heat dissipation member may overlap the image sensor in an optical axis direction.

The moving portion may further include a first layer arranged side by side with the fixed portion and the connecting portion in a direction perpendicular to the optical axis; a second layer having a surface disposed on an upper side of the first layer and a cavity extending through the surface in the optical axis direction; and a third layer disposed between the first layer and the second layer. The heat dissipation member may be disposed in the cavity of the second layer.

Each of the first layer and the third layer may have a surface having a cavity extending through the surface and overlapping the cavity of the second layer.

The heat dissipation member may further include a first extension portion extending in the optical axis direction toward the cavities of the first layer and the third layer.

The moving portion may further include a first layer arranged side by side with the fixed portion and the connecting portion in a direction perpendicular to the optical axis, and a second layer disposed on an upper side of the first layer. The image sensor may be disposed on one side of the second layer, and the heat dissipation member may be disposed on another side of the second layer to overlap the image sensor.

A portion of the heat dissipation member may be disposed between the first layer and the second layer. The first layer and the second layer may be electrically connected through the heat dissipation member disposed therebetween.

A surface of the first layer may have a cavity extending therethrough at a position overlapping the image sensor in the optical axis direction.

The heat dissipation member may further include a first extension portion extending in the optical axis direction toward the cavity of the first layer.

The actuator may further include a base disposed below the sensor substrate. A gap may be formed between the moving portion and the base in an optical axis direction.

The actuator may further include a first driver including a plurality of magnets disposed on the moving frame and a plurality of coils disposed on the fixed frame to face the plurality of magnets.

In another general aspect, a camera module includes a lens module including a lens arranged in an optical axis direction, and an actuator for optical image stabilization configured to move an image sensor on a plane perpendicular to an optical axis. The actuator includes a sensor substrate on which the image sensor is disposed, and a heat dissipation member disposed to overlap the image sensor in the optical axis direction. The heat dissipation member includes a substrate having a through-hole, and a conductive electrode filling the through-hole in a thickness direction.

The sensor substrate may include a fixed portion, a moving portion configured to move relative to the fixed portion on a plane perpendicular to the optical axis, and a connecting portion disposed between the fixed portion and the moving portion to support the movement of the moving portion. The moving portion may include the image sensor and the heat dissipation member.

The camera module may further include a base disposed below the sensor substrate. The heat dissipation member may further include an extension portion extending in the optical axis direction toward the base. A gap may be formed between the base and the extension portion.

The actuator may include: a fixed frame coupled to the fixed portion; a moving frame coupled to the moving portion; and a first driver, disposed separately in the fixed frame and the moving frame, configured to generate a driving force to move the image sensor on the plane perpendicular to the optical axis.

The camera module may further include a focusing actuator configured to move the lens module in the optical axis direction.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a schematic exploded perspective view of the camera module of FIG. 1.

FIG. 3 is an exploded perspective view of an actuator for optical image stabilization according to an embodiment of the present disclosure.

FIG. 4 is an exploded perspective view of a driving part of the actuator for optical image stabilization of FIG. 3.

FIG. 5 is a perspective view of the actuator for optical image stabilization of FIG. 3.

FIG. 6A is a cross-sectional view taken along line I-I′ of FIG. 5.

FIG. 6B is an enlarged view of portion A of FIG. 6A.

FIG. 7A is a cross-sectional view taken along the line II-II′ of FIG. 5.

FIG. 7B is an enlarged view of portion B of FIG. 7A.

FIG. 8 is a diagram illustrating a moving frame of the actuator for optical image stabilization of FIG. 3.

FIG. 9 is a diagram illustrating a moving frame and a sensor substrate of the actuator for optical image stabilization of FIG. 3.

FIG. 10 is a diagram illustrating a coupled state of the moving frame and the sensor substrate of FIG. 9.

FIG. 11 is an exploded perspective view of a sensor substrate according to an embodiment of the present disclosure.

FIG. 12 is a cross-sectional view of the sensor substrate of FIG. 11.

FIGS. 13 to 15 are cross-sectional views of the sensor substrate according to other embodiments of the present disclosure.

FIG. 16 is an exploded perspective view of a focusing actuator according to an embodiment of the present disclosure.

FIG. 17 is a perspective view of the focusing actuator in FIG. 16.

FIG. 18 is a side view of a carrier of the focusing actuator of FIG. 16.

FIG. 19 is a perspective view of a housing of the focusing actuator of FIG. 16.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

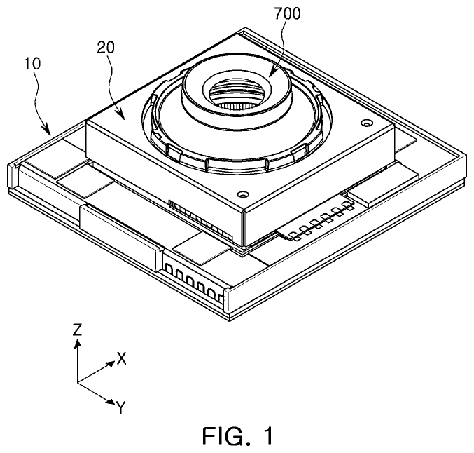

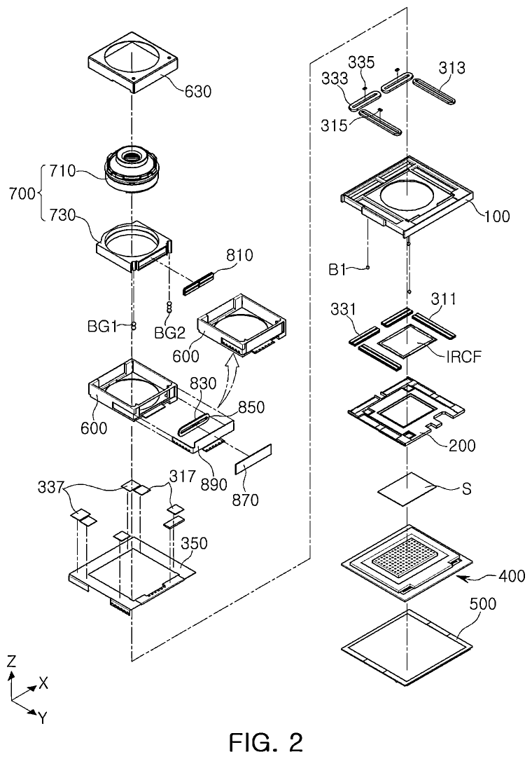

FIG. 1 is a perspective view of a camera module according to an embodiment of the present disclosure, and FIG. 2 is a schematic exploded perspective view of the camera module of FIG. 1.

The camera module 1, according to an embodiment of the present disclosure illustrated in FIG. 1, may be mounted on a portable electronic device. The portable electronic device may be smartphones, tablet PCs, etc.

Referring to FIG. 2, the camera module 1 may include a lens module 700, an image sensor S, a first actuator 10, and a second actuator 20. The first actuator 10 may be an optical image stabilization actuator (OIS actuator), and the second actuator may be a focusing actuator (AF actuator).

The lens module 700 may include one or more lenses and a lens barrel 710 on which the lenses are mounted. When the lens module 700 includes a plurality of lenses, the plurality of lenses may be mounted in the lens barrel 710 in an optical axis direction (Z-axis direction). Additionally, the lens module 700 may include a carrier 730 coupled to the lens barrel 710.

According to an embodiment of the present disclosure, the lens module 700 may be a moving member configured to move in the optical axis direction (Z-axis direction) during focusing. The lens module 700 can be moved in the optical axis (Z-axis) direction by the second actuator 20 for focusing. Meanwhile, the lens module 700 may be a fixed member that does not move during optical image stabilization.

According to an embodiment of the present disclosure, the image sensor S may be a moving member moving in a direction perpendicular to the optical axis (Z-axis) during optical image stabilization. The image sensor S can be moved in a direction perpendicular to the optical axis (Z-axis) by the first actuator 10 for optical image stabilization. That is, the camera module 1 may perform optical image stabilization by moving the image sensor S instead of the lens module 700. Since the image sensor(S) is relatively lighter than the lens module 700, the image sensor (S) can be moved with less driving force, and optical image stabilization can be performed more precisely. In detail, the image sensor S may be moved by the first actuator 10 in a direction perpendicular to the optical axis (Z-axis) or rotated about the optical axis (Z-axis) as a rotation axis.

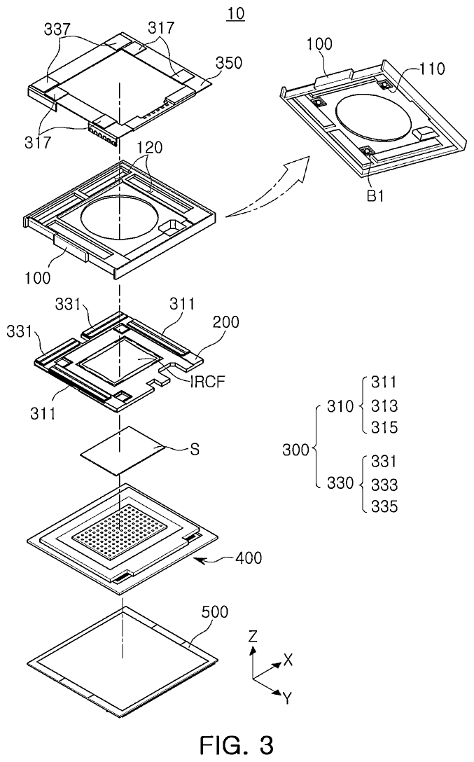

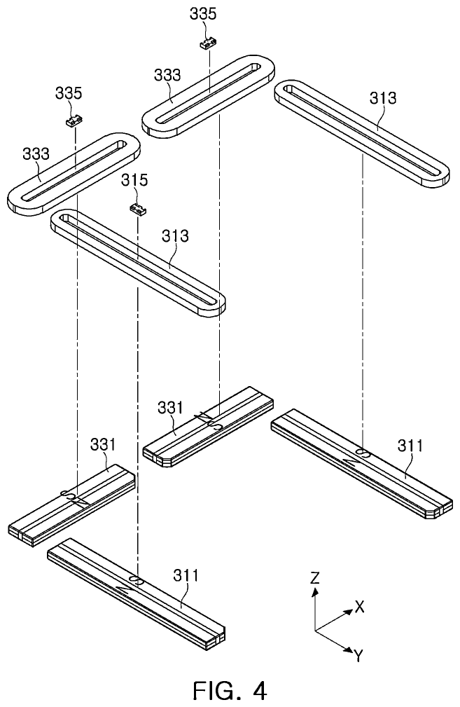

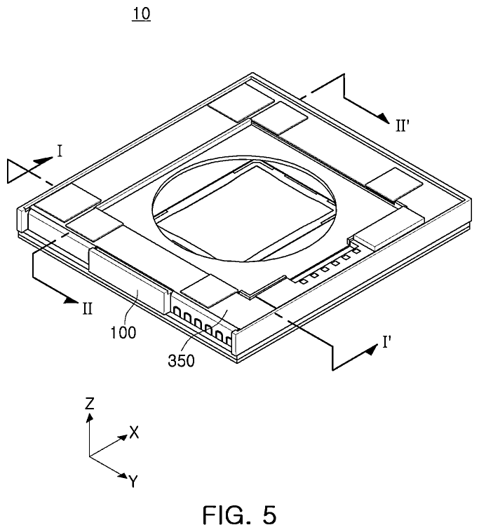

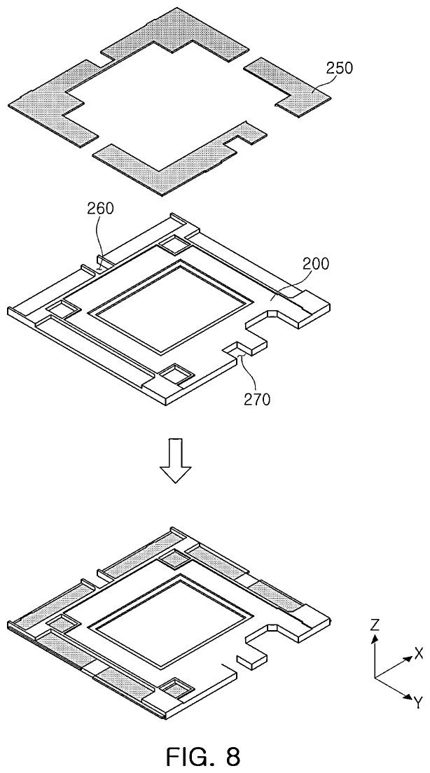

FIG. 3 is an exploded perspective view of an actuator for optical image stabilization according to an embodiment of the present disclosure; FIG. 4 is an exploded perspective view of a driving part of the actuator for optical image stabilization of FIG. 3; FIG. 5 is a perspective view of the actuator for optical image stabilization of FIG. 3; and FIG. 8 is a perspective view of a moving frame of the actuator for optical image stabilization of FIG. 3.

Referring to FIG. 3, the first actuator 10 may include a fixed frame 100, a moving frame 200, a first driver 300, a sensor substrate 400, and a base 500.

The fixed frame 100 may have a rectangular box shape with an opening penetrating the optical axis (Z-axis) direction. The fixed frame 100 may be a fixed member that does not move during focusing and optical image stabilization. The fixed frame 100 may accommodate a moving frame 200, and the like. Additionally, the fixed frame 100 may be coupled to the second actuator 20.

The moving frame 200 may have a rectangular plate shape with an opening penetrating the optical axis (Z-axis) direction. An infrared cut filter (IRCF) may be disposed on an upper side of the moving frame 200, and a sensor substrate 400 may be disposed on a lower side thereof.

The movable frame 200 may be accommodated in a space provided below the fixed frame 100. The moving frame 200 may be a moving member that is moved during optical image stabilization. In an embodiment, the moving frame 200 may be moved in a direction of a first axis (X-axis) perpendicular to the optical axis (Z-axis), and a second axis (Y-axis) perpendicular to both the optical axis (Z-axis) and the first axis (X-axis), or may be rotated about the optical axis (Z-axis) as a rotation axis. That is, the moving frame 200 may move relatively to the fixed frame 100 on a plane perpendicular to the optical axis (Z-axis) while being accommodated in the fixed frame 100.

Referring to FIG. 8, the movable frame 200 may include a reinforcement plate 250 for reinforcing the structural rigidity of the movable frame 200. The reinforcement plate 250 may be formed integrally with the moving frame 200 by way of an insert injection. For example, the reinforcement plate 250 may be formed of stainless steel or replaced with another material.

Referring again to FIG. 3, the image sensor S may be mounted on the sensor substrate 400. The sensor substrate 400 may include a portion coupled to the fixed frame 100 (hereinafter referred to as a fixed portion 430) and a portion coupled to the moving frame 200 (hereinafter referred to as a moving portion 410), and the image sensor S may be mounted on the moving portion 410. Accordingly, the image sensor S and the moving portion 410 can move together with the moving frame 200 on a plane perpendicular to the optical axis (Z-axis).

Referring to FIG. 4, the first actuator 10 may include a first driver 300. The first driver 300 may generate driving force to move the moving frame 200 in the first and second axis directions (X-axis and Y-axis directions) or to rotate the movable frame 200 about the optical axis (Z-axis) as a rotation axis.

The first driver 300, includes a first sub-driver 310, which generates driving force in the first axis direction (X-axis direction), and a second sub-driver 330, which generates driving force in the second axis direction (Y-axis direction).

The first sub-driver 310 includes a first magnet 311 and a first coil 313 arranged to face each other in the optical axis direction (Z-axis direction), and the second sub-driver 330 includes a first magnet 311 and a first coil 313 arranged to face each other in the optical axis direction (Z-axis direction). The first and second magnets 311 and 331 may include the number of coils corresponding to the number of magnets included in the first and second magnets 311 and 331. In embodiment, the first and second magnets 311 and 331 may include two magnets, and the first and second coils 313 and 333 may include two coils.

The first magnet 311 and the second magnet 331 may be arranged perpendicular to each other on a surface of the moving frame 200 facing the fixed frame 100 in the optical axis direction (Z-axis direction). The first coil 313 and the second coil 333 may be disposed on the fixed frame 100 via a first substrate 350. The first coil 313 and the second coil 333 may be disposed in a through-hole 120 formed in the fixed frame 100, and may directly face the first magnet 311 and the second magnet 331 through the through-hole 120.

When power is applied to the first coil 313, the moving frame 200 may be moved in the first axis direction (X-axis direction) by an electromagnetic force between the first magnet 311 and the first coil 313. Likewise, when power is applied to the second coil 333, the moving frame 200 can be moved in the second axis direction (Y-axis direction) by an electromagnetic force between the second magnet 331 and the second coil 333. Since the first magnet 311 and the second magnet 331 are disposed on the moving frame 200, they are moving members that move on a plane perpendicular to the optical axis (Z-axis) together with the moving frame 200, and since the first coil 313 and the second coil 333 are disposed on the fixed frame 100, they may be fixed members that do not move.

Meanwhile, the first sub-driver 310 and the second sub-driver 330 may cooperate to generate a driving force that rotates the moving frame 200 about the optical axis (Z-axis). The rotational driving force may be formed by the resultant force or deviation of the driving forces generated by the first sub-driver 310 and the second sub-driver 330.

Referring to FIG. 4, the first actuator 10 (or the first driver 300) may include a position sensor that detects the position of the moving frame 200. For example, the position sensor may be a hall sensor. The first actuator 10 includes a first position sensor 315 arranged to face the first magnet 311 in the optical axis direction (Z-axis direction) and a second position sensor (335) arranged to face the first position sensor 315 and the second magnet 331 in the optical axis direction (Z-axis direction). The first and second position sensors 315 and 335, together with the first and second coils 313 and 333, may be disposed on the fixed frame 100 via the first substrate 350. In embodiment, the second position sensor 335 may include two position sensors arranged to face each of the two magnets included in the second magnet 331 to detect the rotation of the moving frame 200.

A first ball member B1 may be disposed between the moving frame 200 and the fixed frame 100. The first ball member B1 may be arranged to contact the moving frame 200 and the fixed frame 100, respectively. The first ball member B1 may support the movement of the movable frame 200 while rolling in the direction in which the driving force is generated when the movable frame 200 moves relatively to the fixed frame 100.

The first ball member B1 may include a plurality of balls, and the moving frame 200 and the fixed frame 100 have guide grooves each receiving a plurality of balls on surfaces facing each other in the optical axis direction (Z-axis direction). For example, the lower surface of the fixed frame 100 may include a first guide groove G1, and the upper surface of the moving frame 200 may include a second guide groove G2. The first ball member B1 may be in contact with the first guide groove G1 and the second guide groove G2, respectively. The first guide groove G1 and the second guide groove G2 are formed to be larger than the diameter of the first ball member B1, so that the direction of the rolling movement of the first ball member B1 on a plane perpendicular to the optical axis (Z-axis) may not be restricted.

Referring to FIG. 3, the first actuator 10 may include a yoke to maintain contact between the first ball member B1 and the fixed frame 100 and the moving frame 200. For example, the yoke may be made of a magnetic material. The first actuator 10 includes a first yoke 317 disposed to face the first magnet 311 in the optical axis direction (Z-axis direction), and a second yoke 337 disposed to face the second magnet 337 in the optical axis direction (Z-axis direction). The first and second yokes 317 and 337 may be coupled to the fixed frame 100 through the first substrate 350. The first and second yokes 317 and 337 may be disposed on an opposite side of one side (or the other side) of the first substrate 350 on which the first and second coils 313 and 333 are disposed.

An attractive force may act between the first and second yokes 317 and 337 and the first and second magnets 311 and 331 in a direction facing each other, that is, in the optical axis direction (Z-axis direction). Therefore, an attractive force is formed between the fixed frame 100, on which the first and second yokes 317 and 337 are disposed, and the moving frame 200, on which the first and second magnets 311 and 331 are disposed, so that the first ball member B1 disposed therebetween may maintain contact with the moving frame 200 and the fixed frame 100.

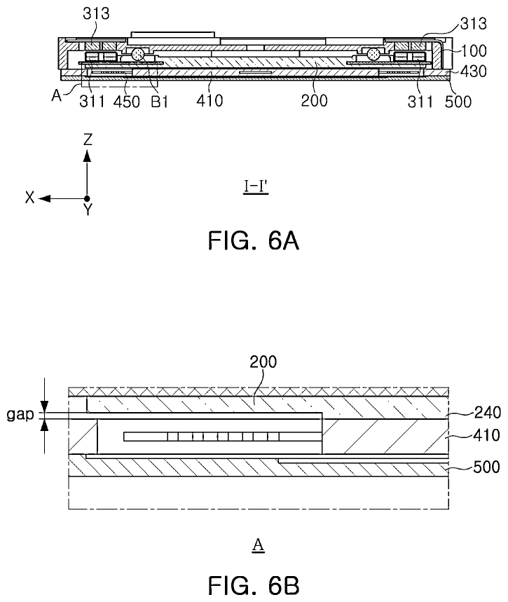

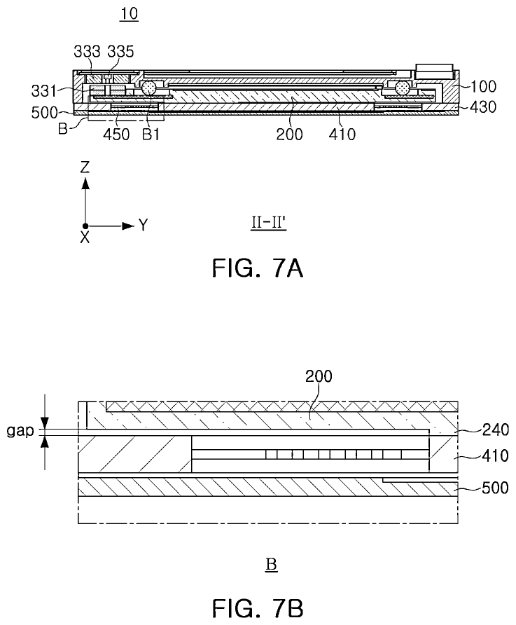

FIG. 6A is a cross-sectional view taken along I-I′ of FIG. 5; FIG. 6B is an enlarged view of portion A of FIG. 6A; FIG. 7A is a cross-sectional view taken along the II-II′ of FIG. 5; and FIG. 7b is an enlarged view of portion B of FIG. 7A.

As illustrated in FIGS. 6A and 7A, when a driving force is generated in the first axis (X-axis) direction, the moving frame 200 may be moved in the first axis (X-axis) direction, and when a driving force is generated in the second (Y-axis) direction, the moving frame 200 may be moved in the second axis (Y-axis) direction. In addition, in cases in which there is a discrepancy between the size of the driving force generated in the first axis (X-axis) direction and the size of the driving force generated in the second axis (Y-axis) direction, the moving frame 200 may be rotated about the optical axis (Z-axis) as the rotation axis. As described above, the moving portion 410 of the sensor substrate 400, on which the image sensor S is mounted, is coupled to the moving frame 200, so that the image sensor S can be moved together with the moving frame 200.

Meanwhile, referring to FIGS. 6B and 7B, the moving frame 200 includes a protrusion 240 protruding toward the sensor substrate 400, and the moving portion 410 may be coupled to the protrusion 240. Therefore, a gap may be formed between the moving frame 200 and the sensor substrate 400 in the optical axis direction (Z-axis direction) in portions other than the protrusion 240 and the moving portion 410, and the fixed portion of the sensor substrate 400 430 may not be interfered with by the movement of the moving frame 200.

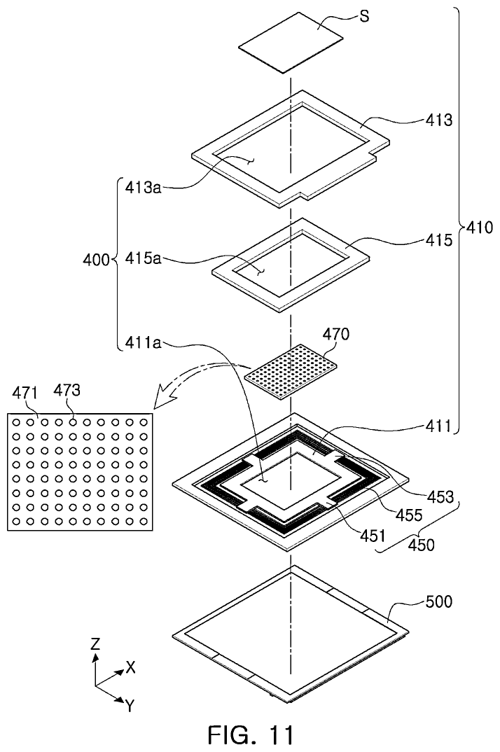

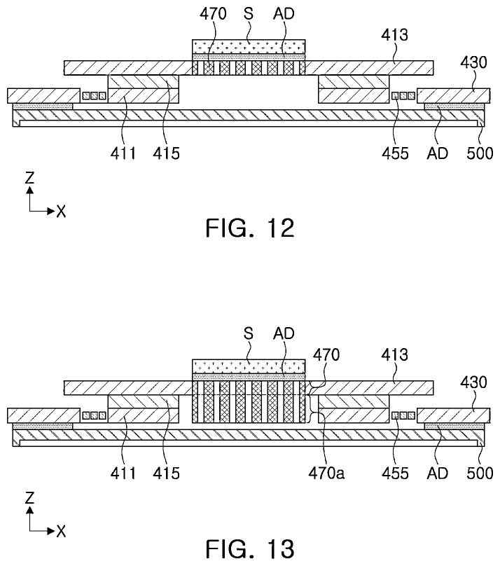

FIG. 11 is an exploded perspective view of a sensor substrate according to an embodiment of the present disclosure. FIG. 12 is a cross-sectional view of the sensor substrate of FIG. 11, and FIGS. 13 to 15 are cross-sectional views of the sensor substrate according to other embodiments of the present disclosure.

Referring to FIG. 11, the sensor substrate 400 may include a moving portion 410, a fixed portion 430, and a connecting portion 450.

The moving portion 410 may be a moving member that is coupled to the lower portion of the moving frame 200 and moves together with the moving frame 200 during optical image stabilization. An image sensor(S) may be mounted on the moving portion 410. The fixed portion 430 may be a fixing member that is coupled to the lower portion of the fixed frame 100 and does not move during optical image stabilization. The fixed portion 430 may be provided to surround the moving portion 410. The connecting portion 450 may be disposed between the moving portion 410 and the fixed portion 430. For example, the connecting portion 450 may be disposed between the moving portion 410 and the fixed portion 430 in a direction perpendicular to the optical axis (Z-axis). The connecting portion 450 may be disposed between the moving portion 410 and the fixed portion 430 to connect the moving portion 410 and the fixed portion 430, and may support the movement of the moving portion 410. In embodiment, the sensor substrate 400 may be a rigid flexible printed circuit board (Rigid Flexible PCB), the moving portion 410 and the fixed portion 430 may be a rigid printed circuit board (Rigid PCB), and the connecting portion 450 may include a flexible printed circuit board (Flexible PCB). Therefore, the connecting portion 450 can support the movement of the moving portion 410 while being bent when the moving portion 410 moves.

The connecting portion 450 may include a plurality of bridge elements 455 disposed between the moving portion 410 and the fixed portion 430. The plurality of bridge elements 455 may be portions corresponding to a flexible printed circuit board (Flexible PCB) that may be bent when the above-described moving portion 410 moves. The plurality of bridge elements 455 may be extended along the outer circumference of the moving portion 410, and each bridge element may be spaced apart by a slit penetrating in the optical axis direction (Z-axis direction).

Additionally, the connecting portion 450 may include a pair of first and second support portions 451 and 453 facing each other in a direction perpendicular to the optical axis (Z-axis). The pair of first support portions 451 face each other in the first axis direction (X-axis direction), and may be connected to the fixed portion 430 and spaced apart from the moving portion 410. The pair of second support portions 453 face each other in the second axis direction (Y-axis direction) and may be connected to the moving portion 410 and spaced apart from the fixed portion 430. Through such a structure, the moving portion 410 can be structurally connected to the fixed portion 430 and have fluidity.

In embodiment, when the moving portion 410 is moved in the first axis direction (X-axis direction), the plurality of bridge elements 455 connected to the first support portion 451 may be bent. When moving in the second axis (Y-axis) direction, the plurality of bridge elements 455 connected to the second support portion 453 may be bent. When the moving portion 410 is rotated about the optical axis (Z-axis), the plurality of bridge elements 455 connected to the first and second support portions 451 and 453 may be bent together.

Referring to FIGS. 11 and 12, the moving portion 410, according to an embodiment of the present disclosure, includes a plurality of layers (hereinafter referred to as a first layer 411, a second layer 413, and a third layer 415), an image sensor(S), and a heat dissipation member 470.

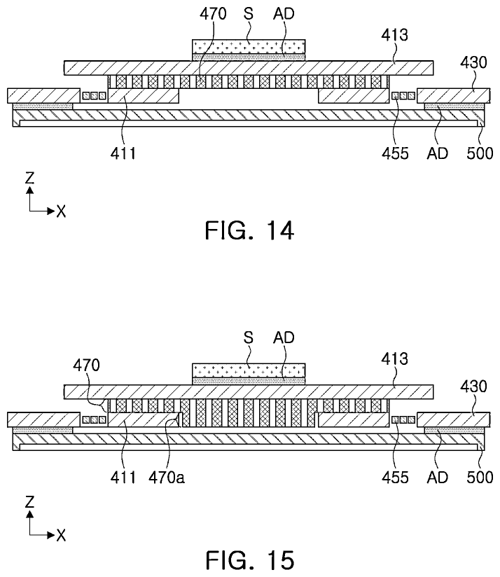

The plurality of layers includes a first layer 411 arranged side by side in a direction perpendicular to the fixed portion 430 and the connecting portion 450 and the optical axis (Z-axis), and a second layer 413 arranged to be spaced apart from the first layer 411 on the upper side of the first layer 411. Additionally, the plurality of layers may include a third layer 415 disposed between the first layer 411 and the second layer 413. The third layer 415 may serve to electrically connect the first layer 411 and the second layer 413. Additionally, the third layer 415 may serve to separate the moving portion 410 and the fixed portion 430. In detail, the second layer 413 may be spaced apart from the fixed portion 430 in the optical axis direction (Z-axis direction) by the third layer 415, and accordingly, when the moving portion 410 is moved on a plane perpendicular to the optical axis (Z-axis), the second layer 413 and the fixed portion 430 may not interfere with each other. The third layer 415 may be optionally provided, and another configuration (for example, heat dissipation member 470) may replace the third layer 415. FIGS. 14 and 15 show embodiment in which the third layer 415 is omitted, which will be described later.

In an embodiment of the present disclosure, the first to third layers 411, 413, and 415 may each include first to third openings 411a, 413a, and 415a penetrating in the optical axis direction (Z-axis direction). The first to third layers 411, 413, and 415 may be arranged so that the first to third openings 411a, 413a, and 415a overlap in the optical axis direction (Z-axis direction), and the image sensor S may be arranged to overlap the first to third openings 411a, 413a, and 415a in the optical axis direction (Z-axis direction).

The heat dissipation member 470 may be disposed in the second opening 413a. That is, the heat dissipation member 470 may be arranged side by side with the second layer 413 in a direction perpendicular to the optical axis (Z-axis). Additionally, it may be arranged to overlap the image sensor S in the optical axis direction (Z-axis direction). Referring to FIG. 12, the image sensor S may be directly attached to one surface of the heat dissipation member 470 through an adhesive AD. In this way, as the image sensor(S) is directly attached to the heat dissipation member 470, the heat dissipation member 470 can directly take away the heat generated from the image sensor(S), thereby improving the heat dissipation performance of the camera module 1.

In consideration of the heat dissipation performance, the heat dissipation member 470 is formed so that the surface in contact with the image sensor(S) has an area that can cover the entire imaging surface (plane perpendicular to the optical axis (Z-axis)) of the image sensor(S). That is, one side of the heat dissipation member 470 parallel to the imaging surface of the image sensor S may be formed to have an area equal to or larger than the imaging surface, and the heat dissipation effect may be improved as the area and volume of the heat dissipation member 470 increase.

According to an embodiment of the present disclosure, the heat dissipation member 470 may have a TSV (Through Silicon Via) structure. The TSV structure refers to a structure in which a plurality of via holes are drilled in a silicon (Si) substrate 471, and the inside of the via holes is filled with a conductive electrode 473. For example, the conductive electrode 473 may be made of copper (Cu). Since the heat transfer coefficient of silicon (Si) is 148 W/m·C and the heat transfer coefficient of copper (Cu) is 401 W/m·C, the heat transfer performance of the heat dissipation member 470 may be very excellent. For example, when considering that the heat transfer coefficient of the PCB board on which the conventional image sensor(S) is disposed is at the level of 10 to 20 W/m·C, heat dissipation performance can be greatly improved.

According to other embodiments of the present disclosure, the heat dissipation performance of the camera module 1 can be improved by increasing the volume of the heat dissipation member 470. In embodiments, the volume of the heat dissipation member 470 may be increased by changing the length and/or height of the heat dissipation member 470.

According to another embodiment, as illustrated in FIG. 13, the volume of the heat radiating member 470 can be increased by increasing the thickness of the heat radiating member 470, that is, the length in the optical axis direction (Z-axis direction). At this time, in order that the movement of the moving portion 410 is not interfered with by the fixing member, the thickness of the heat dissipation member 470 may be increased within a range that does not contact the base 500, which will be described later. In this embodiment, the heat dissipation member 470 may include an extension portion 470a extending in the optical axis direction (Z-axis direction), and the extension portion 470a may be disposed over the third opening 415a and/or the first opening 411a. Even if the thickness of the heat dissipation member 470 increases, the thickness of the camera module 1 may not increase because the heat dissipation member 470 is disposed in the openings 411a, 413a, and 415a of the plurality of layers.

In another embodiment, although not specifically illustrated in the drawings, the length of the heat dissipation member 470 in the first axis and/or second axis direction (X-axis and/or Y-axis direction) may be increased. For example, this may be the case where one side of the heat dissipation member 470 parallel to the imaging surface of the image sensor S has a larger area than the imaging surface, and the area of the second opening 413a may also be changed according to the area of the heat dissipation member 470. Also, in this case, the length of the heat dissipation member 470 can be increased to the extent that the movement of the moving portion 410 is not interfered with by the fixing member.

Meanwhile, as illustrated in FIGS. 14 and 15, in embodiments where the volume of the heat dissipation member 470 is increased, the third layer 415 may be omitted, and the heat dissipation member 470 may replace the third layer 415.

Referring to FIGS. 14 and 15, the moving portion 410 includes a first layer 411, a second layer 413, an image sensor(S), and a heat dissipation member 470, arranged in the optical axis direction (Z-axis direction). The first layer 411 may be arranged side by side with the fixed portion 430 and the connecting portion 450 in a direction perpendicular to the optical axis (z-axis), and the second layer 413 may be arranged to be spaced apart from the first layer 411 on the upper side of the first layer 411.

The heat dissipation member 470 may be disposed between the first layer 411 and the second layer 413. The first layer 411 and the second layer 413 may be electrically connected to each other through a heat dissipation member 470 disposed therebetween. For example, the first layer 411 and the second layer 413 may be electrically connected through the conductive electrode 473 of the heat dissipation member 470. Additionally, the second layer 413 may be spaced apart from the fixed portion 430 by the heat dissipation member 470.

In other embodiments, the first layer 411 may include a first opening 411a penetrating the first layer 411 in the optical axis (Z-axis) direction. However, unlike the above-described embodiment, the second layer 413 may not include the second opening 413a.

An image sensor S may be disposed on one side of the second layer 413, and a heat dissipation member 470 may be disposed on the other side of the second layer 413. That is, the image sensor(S) may overlap the heat dissipation member 470 in the optical axis direction (Z-axis direction) with the second layer 413 in between, and the heat generated from the image sensor(S) may be transmitted to the heat dissipation member 470 through the second layer 413.

In this embodiment as well, heat dissipation performance can be improved by increasing the thickness of the heat dissipation member 470. The heat dissipation member 470 may include an extension portion 470a extending in the optical axis direction (Z-axis direction). The extension portion 470a may be disposed in the first opening 411a, and the thickness thereof can be increased within the range that does not touch with the base 500, which will be described later.

However, since the heat dissipation member 470 is a portion of the moving portion 410 moving on a plane perpendicular to the optical axis (Z-axis), an increase in the volume of the heat dissipation member 470, according to FIGS. 13 to 15, affects the optical image stabilization performance. Therefore, when increasing the volume of the heat dissipation member 470, some via holes are filled with silicon (Si) instead of copper (Cu), which is a material with a relatively high density, or are filled with other materials with a density lower than copper (Cu).

Meanwhile, a base 500 may be disposed below the sensor substrate 400. The base 500 may be provided at the bottom of the sensor substrate 400 to entirely cover the sensor substrate 400, and can prevent foreign substances, etc., from entering the gap between the moving portion 410 and the fixed portion 430.

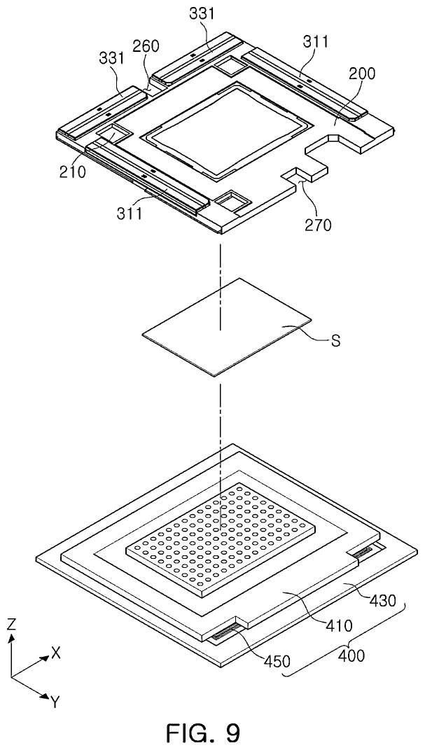

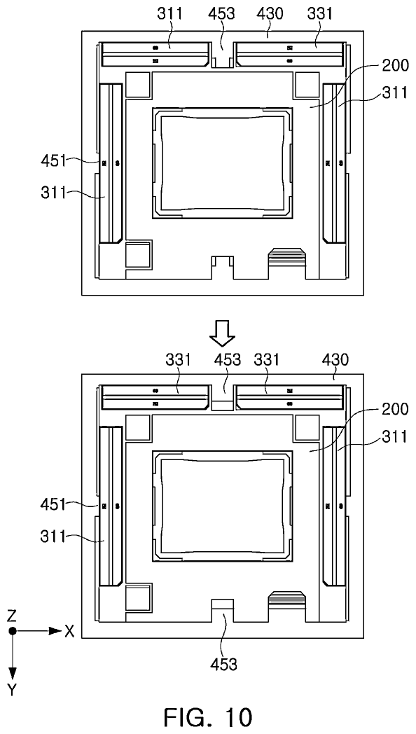

FIG. 9 is a diagram illustrating the moving frame and sensor substrate of the optical image stabilization of FIG. 3, and FIG. 10 is a diagram illustrating a coupled state of the moving frame and the sensor substrate of FIG. 9.

Meanwhile, referring to FIGS. 9 and 10, the moving frame 200 includes a first escape hole 260 and a second escape hole 270 penetrating the moving frame 200 in the optical axis direction (Z-axis direction). With the moving frame 200 coupled to the sensor substrate 400, a portion of the fixing portion 430 and the connecting portion 450 of the sensor substrate 400 through the first and second escape holes 260 and 270, for example, the second support portion 453 may be exposed. Due to this structure, the moving portion 410 of the sensor substrate 400 can have fluidity after being coupled to the moving frame 200. In detail, the sensor substrate 400 is coupled to the moving frame 200 in a state in which the moving portion 410 has no fluidity, and then may have fluidity by cutting a portion of the second support portion 453 exposed through the first and second escape holes 260 and 270.

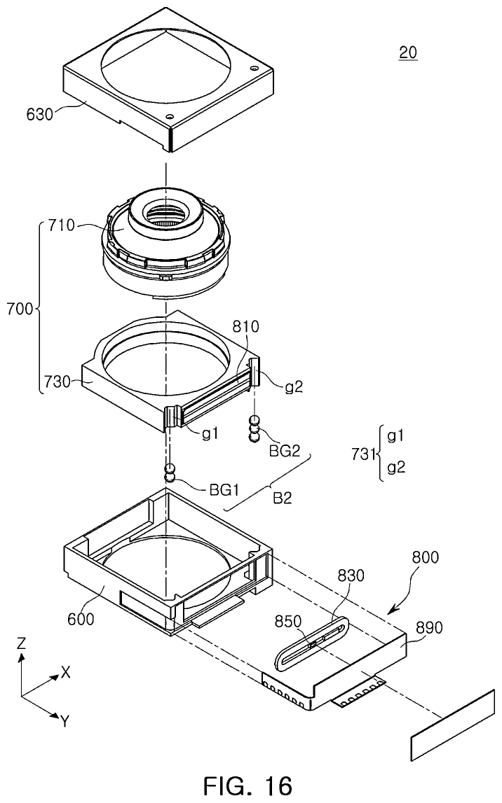

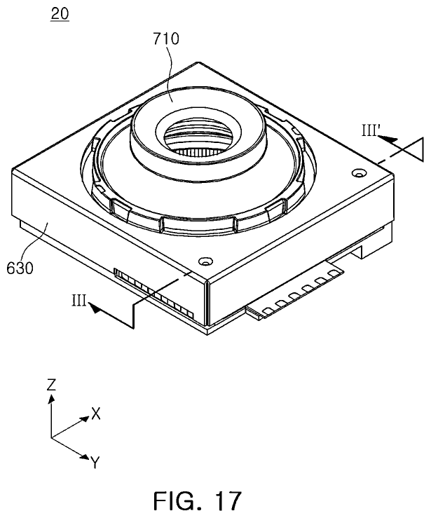

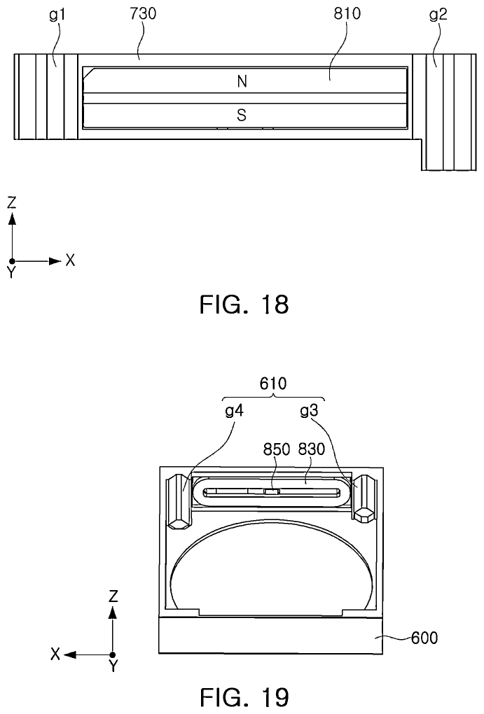

FIG. 16 is an exploded perspective view of a focusing actuator according to an embodiment of the present disclosure; FIG. 17 is a perspective view of the focusing actuator in FIG. 16; FIG. 18 is a side view of a carrier of the focusing actuator of FIG. 16; and FIG. 19 is a perspective view of a housing of the focusing actuator of FIG. 16.

Referring to FIG. 16, the second actuator 20 may include a housing 600, a case 630, a carrier 730, and a second driver 800.

The housing 600 has an internal space and may be formed of a rectangular box shape with an opening penetrating the optical axis direction (Z-axis direction). The carrier 730 may be disposed in the internal space of the housing 600. As described above, the lens barrel 710 may be coupled to the carrier 730, and the lens barrel 710 and the carrier 730 may be moved in the optical axis direction (Z-axis direction). Additionally, the housing 600 may be coupled to the fixed frame 100 and, like the fixed frame 100, may be a fixed member that does not move during focusing and optical image stabilization.

The case 630 may be coupled to a housing 600 to cover the internal space of the housing 600. The case 630 may include a protrusion 631 that protrudes toward the internal space on its lower surface. The protrusion 631 may function as a buffer member while regulating the movement range of the second ball member B2, which will be described later.

The second driver 800 may generate a driving force moving the carrier 730 in the direction of the optical axis (Z-axis direction).

The second driver 800 may include a third magnet 810 and a third coil 830 arranged to face each other in a direction perpendicular to the optical axis (Z-axis). The third magnet 810 may be disposed on one side of the carrier 730, and a back yoke may be disposed between the carrier 730 and the third magnet 810 to prevent magnetic flux leakage. The third coil 830 may be disposed on one side of the housing 600 via a second substrate 890. The third coil 830 may be disposed in a through-hole 820 formed in the housing 600 and may directly face the third magnet 810 through the through-hole 820.

When power is applied to the third coil 830, the carrier 730 may be moved in the optical axis direction (Z-axis direction) by electromagnetic force between the third magnet 810 and the third coil 830. The third magnet 810 is disposed on the carrier 730, so it may be a moving member moving in the optical axis direction (Z-axis direction) together with the carrier 730, and the third coil 830 is disposed on the housing 600, so it may be a fixed member that does not move.

Referring to FIG. 16, the second actuator 20 (or the second driver 800) may include a third position sensor 850 that detects the position of the carrier 730. For example, the third position sensor 850 may be a Hall sensor. The third position sensor 850 may be disposed in the housing 600 via the second substrate 890 to face the third magnet 810 in a direction perpendicular to the optical axis (Z-axis).

A second ball member B2 may be disposed between the carrier 730 and the housing 600. The second ball member B2 may be arranged to contact the carrier 730 and the housing 600, respectively. When the carrier 730 is moved relative to the housing 600 in the optical axis direction (Z-axis direction), the second ball member B2 may support the movement of the carrier 730 while rolling in the optical axis direction (Z-axis direction).

The second ball member B2 may include a plurality of balls arranged in the optical axis direction (Z-axis direction), and the carrier 730 and housing 600 may include a guide groove that accommodates a plurality of balls on surfaces facing each other in a direction perpendicular to the optical axis (Z-axis). For example, one side of the carrier 730 may include a third guide groove 731, and one side of the housing 600 facing one side of the carrier 730 may include a fourth guide groove 610. The third guide groove 731 and the fourth guide groove 610 may have a form extended in the optical axis direction (Z-axis direction), and the second ball member B2 may be disposed between the third guide groove 731 and the fourth guide groove 610.

The second ball member B2 may include a first ball group BG1 and a second ball group BG2 spaced apart in a direction perpendicular to the optical axis (Z-axis). The first and second ball groups BG1 and BG2 may include different numbers of balls, for example, two and three balls, respectively.

The third guide groove 731 includes a first groove g1 and a second groove g2, and the fourth guide groove 610 includes a third groove g3 facing the first groove g1 and a fourth groove g4 facing the second groove g2. The first ball group BG1 may be disposed between the first groove g1 and the third groove g3, and the second ball group (BG2) may be disposed between the second groove g2 and the fourth groove g4.

In an embodiment, the first ball group BG1 may contact the first groove g1 and the third groove g3 at 1 point (2 points) and 2 points (1 point), respectively, and may function as an auxiliary guide. The second ball group BG2 may contact the second groove g2 and the fourth groove g4 at 2 points, respectively, and may function as a main guide.

According to an embodiment of the present disclosure, optical image stabilization is performed by moving the image sensor S to control the driving force precisely. In addition, the temperature of the image sensor S can be effectively reduced by disposing the heat dissipation member 470 of a Through Silicon Via (TSV) structure below the image sensor S.

The actuator for optical image stabilization and the camera module may have improved optical image stabilization and heat dissipation performance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An actuator for optical image stabilization, comprising:
a fixed frame;
a moving frame, accommodated in the fixed frame, configured to move relatively to the fixed frame on a plane perpendicular to an optical axis; and
a sensor substrate, on which an image sensor is disposed, comprising a fixed portion coupled to the fixed frame, a moving portion comprising the image sensor and coupled to the moving frame, and a connecting portion disposed between the moving portion and the fixed portion to support movement of the moving portion,
wherein the moving portion comprises a heat dissipation member dissipating heat generated from the image sensor, and
wherein the heat dissipation member comprises a substrate having a through-hole, and a conductive electrode filling the through-hole.

2. The actuator of claim 1, wherein the heat dissipation member overlaps the image sensor in an optical axis direction.

3. The actuator of claim 2, wherein the moving portion further comprises:
a first layer arranged side by side with the fixed portion and the connecting portion in a direction perpendicular to the optical axis;
a second layer having a surface disposed on an upper side of the first layer and a cavity extending through the surface in the optical axis direction; and
a third layer disposed between the first layer and the second layer,
wherein the heat dissipation member is disposed in the cavity of the second layer.

4. The actuator of claim 3, wherein each of the first layer and the third layer has a surface having a cavity extending through the surface and overlapping the cavity of the second layer.

5. The actuator of claim 4, wherein the heat dissipation member further comprises a first extension portion extending in the optical axis direction toward the cavities of the first layer and the third layer.

6. The actuator of claim 2, wherein the moving portion further comprises:
a first layer arranged side by side with the fixed portion and the connecting portion in a direction perpendicular to the optical axis; and
a second layer disposed on an upper side of the first layer,
wherein the image sensor is disposed on one side of the second layer, and the heat dissipation member is disposed on another side of the second layer to overlap the image sensor.

7. The actuator of claim 6, wherein a portion of the heat dissipation member is disposed between the first layer and the second layer,
wherein the first layer and the second layer are electrically connected through the heat dissipation member disposed therebetween.

8. The actuator of claim 6, wherein a surface of the first layer has a cavity extending therethrough at a position overlapping the image sensor in the optical axis direction.

9. The actuator of claim 8, wherein the heat dissipation member further comprises a first extension portion extending in the optical axis direction toward the cavity of the first layer.

10. The actuator of claim 1, further comprising a base disposed below the sensor substrate,
wherein a gap is formed between the moving portion and the base in an optical axis direction.

11. The actuator of claim 1, further comprising a first driver comprising a plurality of magnets disposed on the moving frame and a plurality of coils disposed on the fixed frame to face the plurality of magnets.

12. A camera module, comprising:
a lens module comprising a lens arranged in an optical axis direction; and
the actuator of claim 1.

13. A camera module, comprising:
a lens module comprising a lens arranged in an optical axis direction; and
an actuator for optical image stabilization configured to move an image sensor on a plane perpendicular to an optical axis,
wherein the actuator comprises a sensor substrate on which the image sensor is disposed, and a heat dissipation member disposed to overlap the image sensor in the optical axis direction, and
wherein the heat dissipation member comprises a substrate having a through-hole, and a conductive electrode filling the through-hole in a thickness direction.

14. The camera module of claim 13, wherein the sensor substrate comprises:
a fixed portion;
a moving portion configured to move relative to the fixed portion on a plane perpendicular to the optical axis; and
a connecting portion disposed between the fixed portion and the moving portion to support the movement of the moving portion,
wherein the moving portion comprises the image sensor and the heat dissipation member.

15. The camera module of claim 14, further comprising a base disposed below the sensor substrate,
wherein the heat dissipation member further comprises an extension portion extending in the optical axis direction toward the base, and
wherein a gap is formed between the base and the extension portion.

16. The camera module of claim 14, wherein the actuator comprises:
a fixed frame coupled to the fixed portion;
a moving frame coupled to the moving portion; and
a first driver, disposed separately in the fixed frame and the moving frame, configured to generate a driving force to move the image sensor on the plane perpendicular to the optical axis.

17. The camera module of claim 13, further comprising a focusing actuator configured to move the lens module in the optical axis direction.
